(19) United States
(12) Patent Application Publication
(10) Pub. No.: US 2021/0000673 A1
(43) Pub. Date: Jan. 7, 2021

(54) Fiberglass Coffin/Casket

(71) Applicant: Naomi Yvonne Hanna Palmer, Miramar, FL (US)

(72) Inventor: Naomi Yvonne Hanna Palmer, Miramar, FL (US)

(21) Appl. No.: 16/460,810

(22) Filed: Jul. 2, 2019

(51) Int. Cl. A61G 17/007

(52) U.S. Cl. CPC A61G 17/0166; A61G 17/0136

(57) ABSTRACT

An invention intended to improve the outer material[s] of the average or traditional coffin/casket (which is presently being made of steel or wood). The coffin or casket (if manufactured), would be made of fiberglass (instead of steel or wood); thus, it would be easier, to lift or transport, and more cost-efficient.

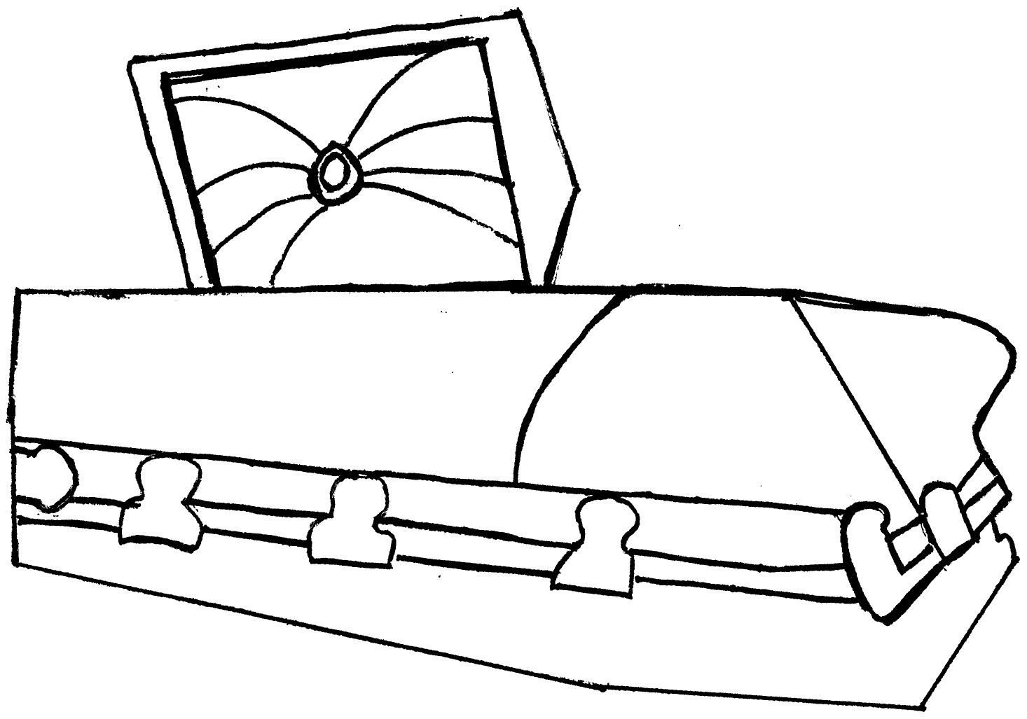

### BACKGROUND

A steel or wooden coffin/casket containing a human corpse or remains of a human, is often heavy and hard to handle; they are also costly.

### SUMMARY

The fiberglass coffin/casket invention (idea) is intended to resemble (and be used similarly), as any average or ordinary traditional steel or wood coffin/casket. Thus, its purpose would be to serve as a container for a preserved human corpse or human remains. The fiberglass coffin/casket is intended to offer an alternative (light-weight) type of material (fiberglass) for covering the outer part(s) of a coffin/casket. Therefore, if manufactured, this product should be an easier way of lifting or transporting a coffin/casket with a human corpse or human remains (as compared to transporting or lifting a steel or wooden coffin/casket containing human remains of the same weight).

Should the human corpse or human remains be transported by as commercial aircraft or a commercial ship (when weight is a determining factor of cost), it is expected that the cost of transporting a human corpse or human remains by either of the two previously mentioned (steel or wood coffins/casket would be more than the cost of transporting a fiberglass coffin/casket of the same length, width, and height (containing a human corpse or human remains of the same weight).

When comparing average cost of making musical instruments, and car parts using with the cost of making the similar items from fiberglass, it was found that (on average), fiberglass items were less expensive than similar ones made of steel.

“Fiberglass doors resist wear and tear better than steel. They can be painted or stained, and are moderately priced and dent-resistant, and require little maintenance . . . ” (Google search: https://www.consumerreports.org).

### BRIEF DESCRIPTION OF DRAWING

The simple 3-D drawing being submitted, shows the: top, front, left side, right side, and bottom of an open coffin/casket (fiberglass). Any measurements given, only represent the measurements of the drawn picture (not the actual or real size of a coffin/casket).

The top of the drawing shows the open cover of a coffin/casket (it is shown, indented from the left side of the drawing).

The straight line drawn (just beneath the coffin's/casket's open cover), is 8″ (eight inches) long; it curves slightly at the right (providing somewhat of a 3-D look), that slight curve measures approximately 2″ (two inches) in length; the straight line intersecting the slightly right curved one, represents the full length of the top of the drawn coffin/casket.

The outer left side of the full length of the drawing, is approximately 2″ (2 inches) in height. The bottom of the coffin/casket is represented by two connecting obtuse angles (three straight lines) intended to provide somewhat of a 3-D look for the drawing. Finally, going to the right foot area, a small curved line adjoins a small straight one, enclosing the coffin/casket at the bottom: each line is about ¼″ (one fourth inch). On the top of the drawing of the casket, near the foot area are: a curved line, about 2″ (two inches) and a diagonal line, about 2 Vin (two and a half inches) long; the curved and diagonal lines, are only intended to represent a design on the top of the coffin/casket. The lower three lines near the bottom and the foot area of the drawing (of the coffin/casket) are intended to represent thick bars, which serve as rests or holders, for the handles (depicted by: three key-hole shaped objects in the lower-front portion of the drawing, and two smaller, slightly different looking ones, on the bottom left side and foot area (right side of drawing).

1. The fiberglass coffin/casket (invention) is intended to resemble (and be used similarly), as any average/ordinary traditional (steel or wood) coffin/casket; when compared to an average traditional coffin/casket of the same height, width, length and depth, the fiberglass coffin/casket would weigh less than either of the traditional ones mentioned.
